(19) United States
(12) Patent Application Publication
(10) Pub. No.: US 2007/0248496 A1
(43) Pub. Date: Oct. 25, 2007

(54) Resealer of test tubes for clinical analyses fed from ready-to-use containers of sealing tape

(75) Inventors: Maurizio Bondioli, Casalecchio di Reno (BO) (IT); Carlo Innocenti, Bologna (IT)

Correspondence Address: John S. Egbert;Egbert Law Offices, 7th Floor, 412 Main Street, Houston, TX, 77002, US

(73) Assignee: ECOCAP'S S.R.L., Casalecchio di Reno (BO) (IT)

(21) Appl. No.: 11/410,316

(22) Filed: Apr. 25, 2006

(51) Int. Cl. B01L 3/00

(52) U.S. Cl. 422/99

(57) ABSTRACT

The invention relates to an automatic machine designed to reseal test tubes for clinical analyses with aluminum sealing tape housed in ready-to-use, cassette-type containers. The machine uses a heat-sealing process to apply a piece of aluminum foil, which will form the cap, over the mouth of the test tube, causing it to adhere to the edge of the test tube itself to achieve perfect resealing.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present industrial invention relates to an automatic machine designed to reseal test tubes for clinical analysis with aluminum caps obtained from a reel housed in a ready-to-use container. The cap for test tubes has been claimed by the same applicant under Italian patent BO2003A 000542.

### BACKGROUND OF THE INVENTION

With particular reference to the present state of the art, test tubes containing already analyzed samples, without the original sealing cap or stopper, are collected in multiple supports which are hastily packed and placed in special cold storage compartments.

Fluid spillage from the test tubes is prevented solely by precarious coverings wrapped completely round the support. The risk of spillage or leaks in the event of an accident is thus very high, as is the risk of personnel being contaminated by samples.

To overcome such problems, a machine has been devised to reseal test tubes containing already analyzed samples.

This solution is useful both in that it allows the test tube container to be handled in complete safety and facilitates subsequent disposal of the test tubes themselves.

### BRIEF SUMMARY OF THE INVENTION

The machine uses a heat-sealing process to apply a piece of aluminum foil, which will form the cap, over the mouth of the test tube, causing it to adhere to the edge of the test tube itself to achieve perfect resealing.

Another aim of the invention is to enable the aluminum foil to be fed to the machine rapidly, and in a manner that is easy for any operator, by means of a ready-to-use cassette-type container housing reels of aluminum tape.

This also avoids waste of aluminum tape, which, by its very nature, is difficult to handle.

These and other characteristics will now become more apparent upon reading the description of a simple embodiment of the invention, which is given for purely illustrative purposes and does not restrict the scope of this patent.

### BRIEF DESCRIPTION OF THE SEVERAL VIEWS OF THE DRAWINGS

FIG. 1 shows a front schematic view of the machine.

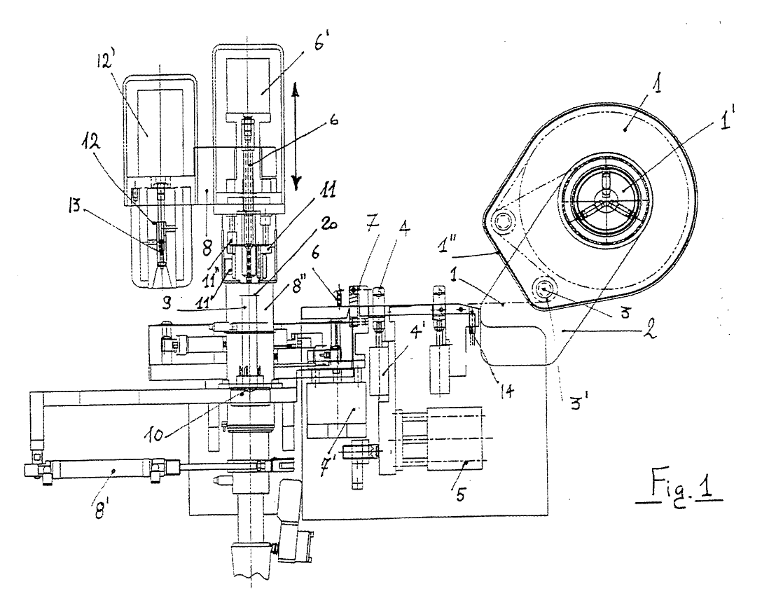

FIG. 2 shows a top plan view of the machine as viewed from above.

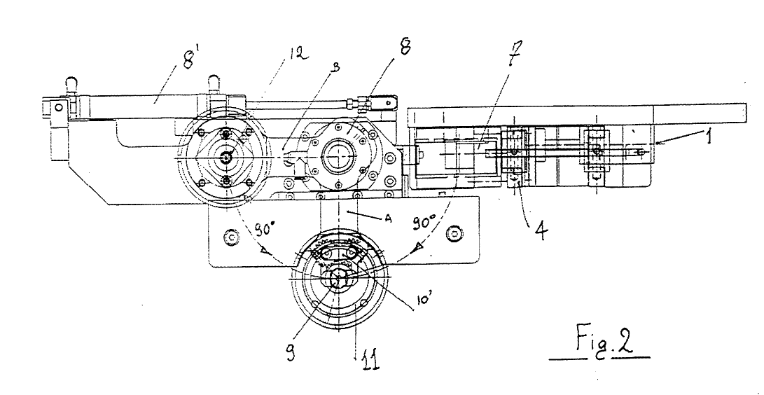

FIG. 3 shows a side schematic view of the machine.

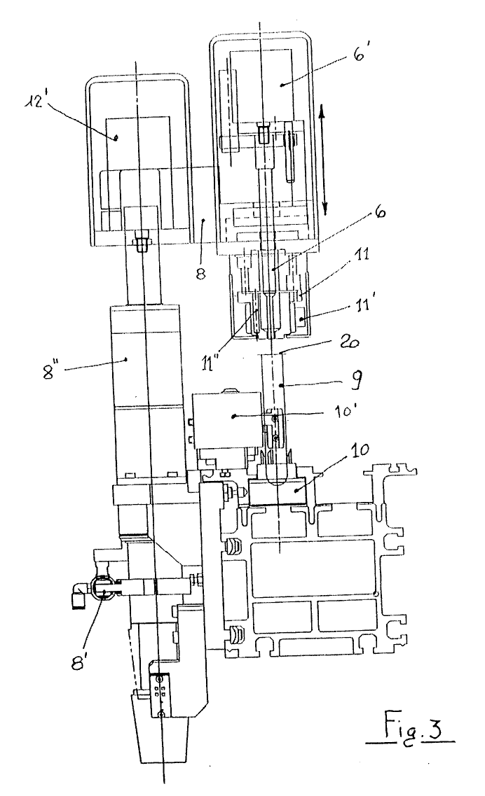

FIG. 4 shows another side schematic view of the machine.

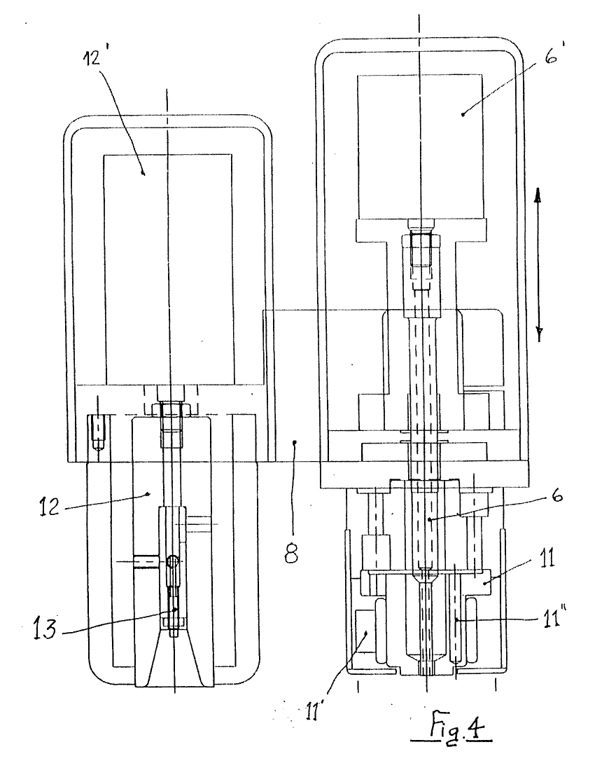

FIGS. 5,6,7 show an enlarged schematic view and a median cross section view of the cassette fitted in place on the machine and another, different cross section view of the cassette alone.

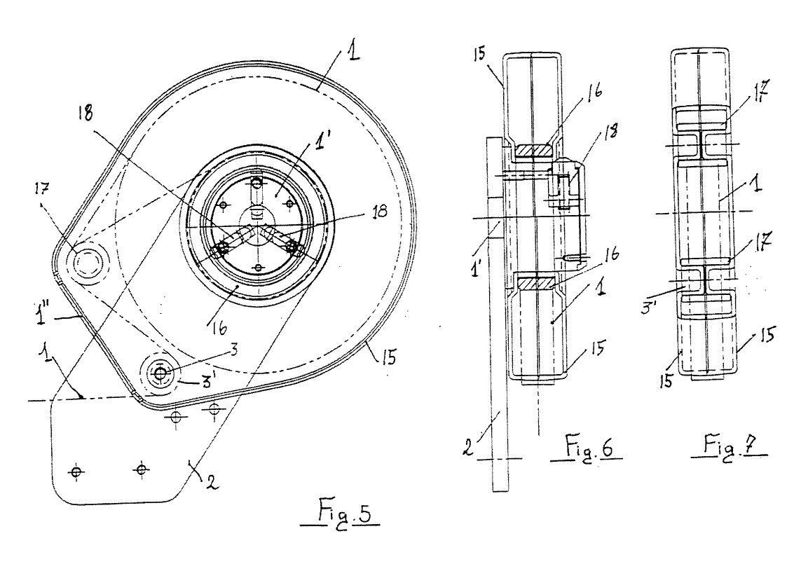

FIG. 8 shows a schematic view of the cassette fitted on the machine as viewed from the side.

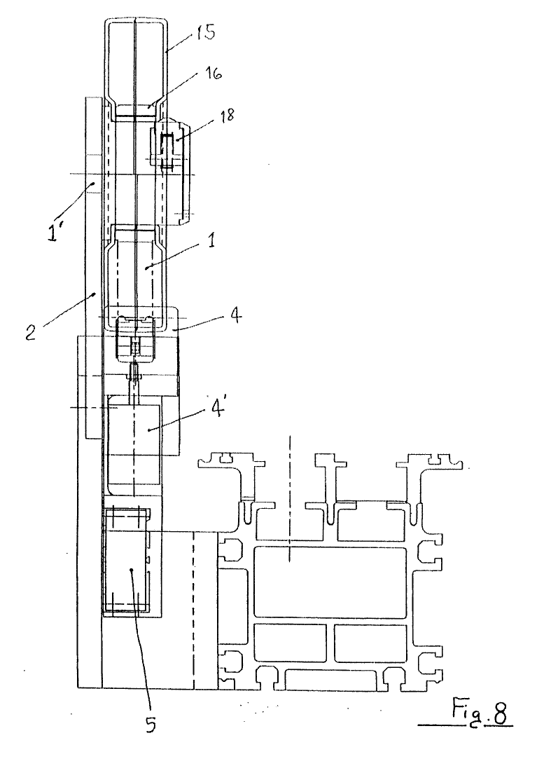

FIG. 9 shows a schematic view of the test tube to be sealed.

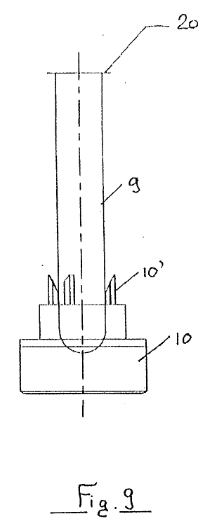

### DETAILED DESCRIPTION OF THE INVENTION

With reference to these figures, 1 indicates the reel of aluminum tape, 1′ the self-centering and self-locking cassette holder present on the automatic machine, 1″ the self-adhesive label that engages the end of the tape as it comes out of the cassette, 2 the resting surface serving as a guide for positioning the cassette together with the stud 3, which must engage the cavity 3′ fashioned in the cassette itself. 4 indicates the tape feed gripper driven by cylinder 4′ for gripping and by cylinder for conveying the tape. 6 indicates the vacuum-operated pick-up tube driven by cylinder 6′ in the descent toward the tape. 7 indicates the blade for cutting the tape (1), driven by cylinder 7′, which determines the pieces 20 to be used to form the resealing caps.

After picking up a cap (20), the tube (6) rises, while the dual head 8 driven by cylinder 8′ rotates 90° in a clockwise direction to move into the sealing position.

9 indicates the test tube to be sealed, supported by an element 10 which holds it in place by means of a gripper 10′. The head (8) is moved vertically downward by cylinder 8″ so that it may heat the cap (20) in contact with the test tube. 11 indicates the sealing device rigidly connected in A to the dual head (8), 11′ the heating element and 11″ the temperature probe.

When the sealing phase is completed, the head (8) rises and rotates 90° in an anticlockwise direction to get ready for a new cycle. This rotation enables the forming element 12, rigidly connected in B to the dual head (8), and driven by cylinder 12′, to position itself on the test tube (9) and, as it is lowered, to adhere to the cap (20) so as to mould it around the outer surface of the test tube (9).

13 indicates a sensor that checks for the presence of a cap sealed onto the top of the test tube. The cap's absence will cause the cycle to be repeated. If the check is negative, a second time, an alarm will be triggered. 14 indicates a second sensor that checks for the presence of the aluminum foil to be fed to the machine. The absence or breakage of the sealing tape will bring the cycle to a stop and trigger an alarm. 15 indicates the two half-shells making up the cassette, which is shaped so as to house on the inside a reel of aluminum tape (1) wound around a plastic hub 16 and two take-up spools indicated by the number 17. The shape of the hole in the center of the cassette (15) is such as permit the cassette itself to be fitted onto the reel holder (1′). The spring-operated locking teeth 18 are compressed on entry, facilitated by the shape of the central hole of the cassette, and once the latter has been fitted they expand to lock the cassette containing the reel in place. Correct fitting of the cassette is assured by the stud (3) which, by engaging the cavity (3′), ensures that the cassette is correctly positioned on the machine.

The reel contained in the cassette is of a length such as to enable approximately 16000 test tubes to be sealed with an equal number of individual pieces. The machine counts up to 15000 cycles before giving a warning that the reel is about to run out. On reaching 16000 cycles the machine will stop and request the operator to replace the cassette.

In practice, the construction details, dimensions, materials, shape and other aspects of the invention may vary without departing from the scope of the present industrial patent. In fact, the invention thus conceived lends itself to numerous adaptations and variants, all falling within the realm of the inventive concept. In addition, all the elements may be replaced by other technically equivalent ones.

We claim:

1. Resealer of test tubes for clinical analyses fed from ready-to-use containers of sealing tape, said resealer comprising:
a sealing tape feed device;
a conveyance device;
a cutting device;
a sealing device; and
a forming device,
wherein a hot-melt lacquer coated aluminum sealing tape is fed from reels housed inside special cassettes comprised of two half-shells internally incorporating a plastic winding hub and two take-up spools, each cassette having a through hole in a center thereof to be locked in place by elastic locking teeth supported by a reel holder,
wherein the cassette has a cavity engaged by a stud serving as a guide for positioning together with the resting surface,
wherein said conveyance device comprises a feed gripper driven by a cylinder for gripping, and a cylinder for conveyance,
wherein said cutting device is comprised of a vacuum-operated tube driven by a cylinder, and a cutting blade driven by another cylinder,
wherein said sealing device has a dual head, driven by a cylinder for clockwise and anticlockwise 90° rotations and by another cylinder for vertical movement, rigidly connected to said sealing device, said sealing device comprising a heating element and temperature probe, and
wherein said forming device is driven by a cylinder (12′) a test tube to be sealed being supported by an element and held in place by a gripper.

2. Resealer of test tubes for clinical analyses fed from ready-to-use containers of sealing tape according to claim 1, further comprising:
a sensor for verifying presence of a sealed cap on the test tube, and
another sensor for verifying presence of the aluminum foil.

3. Resealer of test tubes for clinical analyses fed from ready-to-use containers of sealing tape according to claim 1, wherein an assembled reel is UV treated.
